(19) United States
(12) Patent Application Publication
(10) Pub. No.: US 2005/0013199 A1
(43) Pub. Date: Jan. 20, 2005

(54) Tide clock utilizing GPS data

(76) Inventors: Daniel R. Danks, Portland, OR (US); Mary K. Danks, Memphis, TN (US); Richard T. Danks, Fresno, CA (US); Christopher L. Morton, Memphis, TN (US); David O. Whipple, Memphis, TN (US); Kathleen M. Danks, Seal Rock, OR (US)

Correspondence Address: GLENN C. BROWN, PC, 777 NW WALL STREET, SUITE 308, BEND, OR, 97701, US

(21) Appl. No.: 10/763,342

(22) Filed: Jan. 23, 2004

Related U.S. Application Data
(60) Provisional application No. 60/488,132, filed on Jul. 16, 2003.

(51) Int. Cl. G04B 19/26

(52) U.S. Cl. 368/19

(57) ABSTRACT

A tide clock that utilizes global positioning system data to calculate tidal events. The tide clock includes a receiver that receives global positioning data describing the clock's position, and a memory having algorithms selectable to calculate the time of a tidal event for multiple locations.

### BACKGROUND OF RELATED APPLICATION

This application is a continuation-in-part of U.S. provisional patent application Ser. No. 60/488,132, filed on Jul. 16, 2003. The priority of the prior application is expressly claimed and its disclosure is hereby incorporated by reference in its entirety.

### BACKGROUND OF THE INVENTION

This invention relates to predicting tidal fluctuations, and in particular to a clock that accurately predicts tidal information for highly specific localities.

Tides vary with and are predicted based on the movements and locations of the earth, sun and moon. This information, in particular the length of the “lunar day”, i.e., 25 hours and 50 minutes, is used to generate tide tables that are compilations of predicted high and low tides for specific locations. Tide tables generated in this way are relatively accurate for the particular location for which they are calculated, but for other locations one must adjust the times reported in the tide tables based on empirical variations in the occurrence of tidal events relative to the specified location.

Tide clocks have been developed that also predict tidal changes by use of the same astronomical data as is used to generate tide tables. One such available tide clock is shown in FIG. 1. However, as with tide charts, the data on which the operation of tide clocks are based are based on predetermined locations, typically large ports, cities or geographical features such as the entrance to a river or bay, and are not accurate to predict tide occurrences at other locations that are even a couple of miles away.

One must also be able to account for irregularities in tidal occurrences in particular parts of the world such as the Pacific Coast of North America, where tidal cycles are rendered irregular. Those familiar with those areas can sometimes roughly account for local variations, but cannot reliably do so. Other users, such as the operators of large commercial and recreational vessels, who must time their travels precisely according to the tides for safe and efficient operation, require both more precise and more reliable information than the local rules of thumb are able to provide.

The need for precise tidal information at locations other than those popular locations has led to the development of algorithms that predict variations in tidal occurrences based on a location relative to a popular location for which information is readily available. For example, if one is interested in tidal occurrences north or south of a location such as San Francisco, one can use one or more empirically derived equations to predict the variations in tidal occurrences relative to those predicted for San Francisco. The same is true for areas lying between an ocean coast line and a location on an inland salt water body such as a sound or bay. However, even having the algorithm applicable for a particular geographic area, in order to obtain precise tidal information at these other locations, one must also know the precise geographical coordinates of the location. Maps and other sources of such information normally fail to provide sufficiently detailed geographical coordinates to permit accurate, precise prediction of tidal occurrences in all but the most popular locations such as major cities and ports.

### SUMMARY OF THE INVENTION

This invention provides a solution to the problem of acquiring accurate, precise information about the timing of tidal occurrences by providing a tide clock having a memory holding the specific computational algorithms for one or more locations, and that also includes an apparatus for communicating with the global positioning system (GPS) to determine the clock's location to a very high degree of accuracy, e.g. 100 meters or less.

### BRIEF DESCRIPTION OF THE DRAWINGS

FIG. 1 is a perspective view of a prior art tide clock.

FIG. 2 is a schematic view of a preferred embodiment of the invention.

FIG. 3 is a schematic view of a second preferred embodiment of the invention that includes a display.

FIG. 4 is a schematic view of a third preferred embodiment of the invention having a data base.

FIG. 5 is a schematic view of a fourth preferred embodiment of the invention and having a data input apparatus.

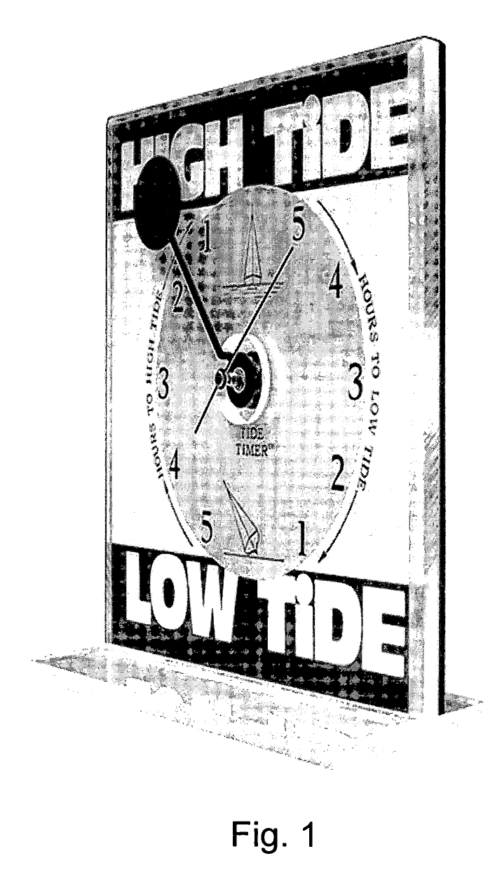

### DETAILED DESCRIPTION OF THE INVENTION

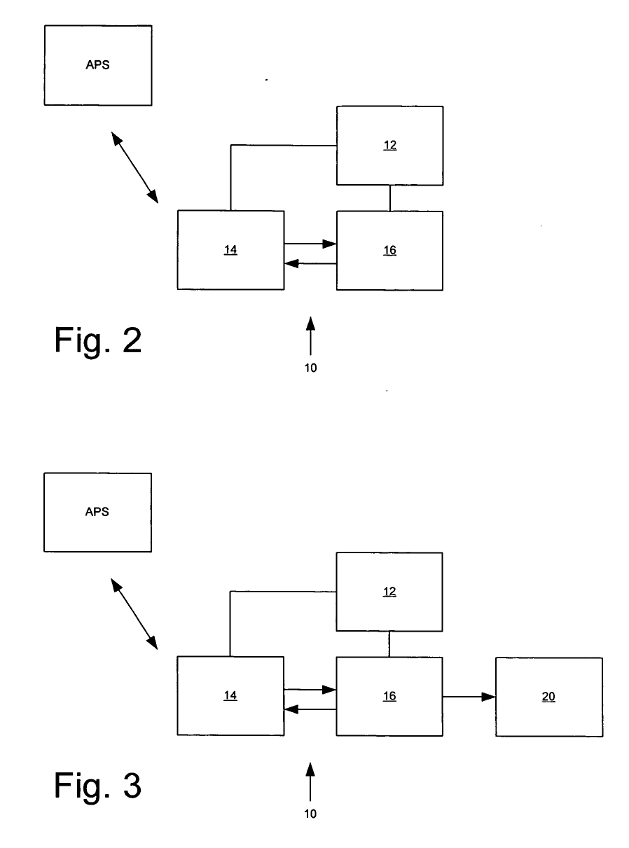

In one embodiment shown in FIG. 2 a tide clock according to the present invention includes a memory that contains a plurality of algorithms, each of which is applicable to predict tidal occurrences in a particular geographical area. The tide clock also includes a global positioning data receiver 14 that is operable to communicate with the satellites of the GPS to determine the tide clock's precise location at any time. Once activated, the processor 16 determines the geographical location of the tide clock and predicts upcoming tidal occurrences using the location-specific algorithm stored in the memory. The time of the tidal occurrence is then displayed on a display 20 as shown in FIG. 3.

In one embodiment, the user preselects the geographic region from the memory using an interface. In a preferred embodiment the processor accesses the memory to determine and extract the location-identifying information using the GPS-derived coordinates, and without the need for any user intervention. The availability of large amounts of computer memory in compact and relatively inexpensive form make it practicable to store algorithms and GPS data for large numbers of locations in a small portable device that can be readily stored on nearly any vessel or location.

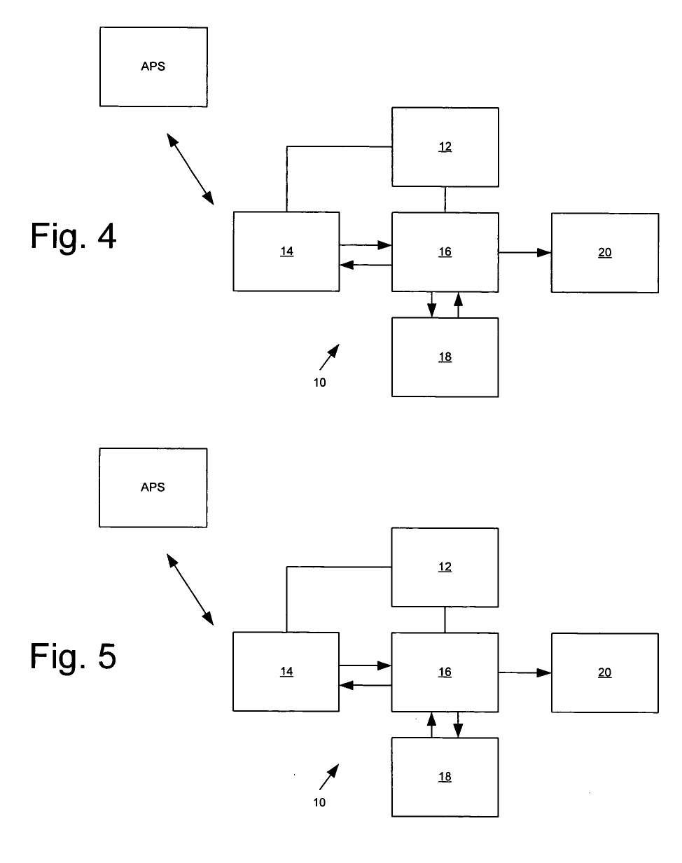

Once the appropriate algorithm has been selected, the GPS-derived coordinates are utilized with the algorithm to generate a highly accurate prediction of one or more upcoming tidal events. In some instances, the algorithm utilizes the GPS coordinates directly in the calculations. In other instances the algorithm utilizes the differences between the site-specific GPS coordinates and reference coordinates for another location such as a nearby city or geographical feature. Where reference coordinates are required they are preferably stored in the memory along with the selection of algorithms. The reference coordinates are preferably accessed automatically by the processor without user intervention, although the invention includes embodiments wherein the user is prompted or required to identify a nearby reference location through an interface. In the embodiment shown in FIG. 4, the invention includes a data input 18 such as a keyboard to input GPS data to the processor.

In another embodiment of the invention shown in FIG. 5, the tide clock periodically is connected to a data base of algorithms and GPS coordinates to receive updated algorithms, coordinates, or to download information for new locations. The tide clock can be connected to the data base in any applicable manner such as a telephone line, through connection to the world wide web, or by soliciting and receiving signals from a satellite.

Those of skill in the art will recognize that while the invention has been described by reference to the foregoing embodiments, numerous variations are possible without departing from the scope of the following claims.

1. A tide clock comprising:
a receiver in communication with a global positioning system and adapted to receive global positioning coordinates;
a memory having at least one algorithm for calculating a tidal occurrence, the algorithm including terms related to global positioning coordinates; and,
a processor in communication with the memory and operable to access the global positioning coordinates and the at least one algorithm to calculate a tidal occurrence at a predetermined location related to the global positioning coordinates.

2. A tide clock according to claim 1 further comprising the receiver being operable to automatically obtain global positioning coordinates from a global positioning system.

3. A tide clock according to claim 1 further comprising the memory having a plurality of algorithms stored therein.

4. A tide clock according to claim 1 further comprising a display in communication with the processor and adapted to display the calculated time of the tidal occurrence.

5. A tide clock according to claim 1 comprising the processor being operable to select an algorithm from the memory based on the global positioning coordinates obtained from the global positioning system.

6. A tide clock according to claim 1 wherein the processor is in communication with a data base and operable to acquire at least one algorithm from the data base.

7. A tide clock according to claim 6 wherein the data base is remote from the tide clock.

8. A tide clock according to claim 1 further comprising a data input apparatus and adapted to input global positioning data.

9. A tide clock according to claim 1 further comprising the data input apparatus operable by a user to manually input global positioning data.
